(19) United States
(12) Patent Application Publication
(10) Pub. No.: US 2005/0056299 A1
(43) Pub. Date: Mar. 17, 2005

(54) Toothpick

(76) Inventor: Peter C. T. Chang, Taipei (TW)

Correspondence Address: LAW OFFICES OF DAVID PAI, 1001 FOURTH AVENUE, SUITE 3200, SEATTLE, WA, 98154, US

(21) Appl. No.: 10/864,177

(22) Filed: Jun. 9, 2004

(30) Foreign Application Priority Data
Sep. 16, 2003 (TW) 092216588

(51) Int. Cl. A61C 15/00

(52) U.S. Cl. 132/329

(57) ABSTRACT

A toothpick is constructed to include a straight shank, and an angular tip forwardly extended from one end of the shank and defining with the shank a contained angle for easy insertion into the mouth to remove bits of food from the teeth.

### BACKGROUND OF THE INVENTION

1. Field of the Invention

The present invention relates to a toothpick and, more particularly, to a toothpick which has an angular tip.

2. Description of the Related Art

Regular toothpicks are made of bamboo or plastic material and to be thrown away after one use. In order to reduce the cost, regular toothpicks have a straight shape with one or both ends pointed. However, it is inconvenient to insert a straight toothpick into the mouth and then to move the toothpick over gaps in between the teeth. Further, the disposable design of conventional toothpicks is not preferable to environmental protection.

### BRIEF SUMMARY OF THE INVENTION

The present invention has been accomplished under the circumstances in view. It is one object of the present invention to provide a toothpick which is orthopedically engineered. It is another object of the present invention to provide a toothpick which is reusable and specifically designed for personal use. To achieve these and other objects of the present invention, the toothpick comprises a straight shank, and an angular tip forwardly extended from one end of the shank and defining with the shank a contained angle for easy insertion into the mouth to remove bits of food from the teeth. The contained angle is designed to be within 10˜60°, preferably 40˜45°.

### BRIEF DESCRIPTION OF THE DRAWINGS

FIG. 1 is a side view of a toothpick according to the present invention.

FIG. 2 is a sectional view in an enlarged scale taken along line II-II of FIG. 1.

FIG. 3 is a side view of an alternate form of the toothpick according to the present invention.

FIG. 4 is a sectional view in an enlarged scale taken along line IV-IV of FIG. 3.

FIG. 5 is a sectional view in an enlarged scale taken along line V-V of FIG. 3.

### DETAILED DESCRIPTION OF THE PREFERRED EMBODIMENT

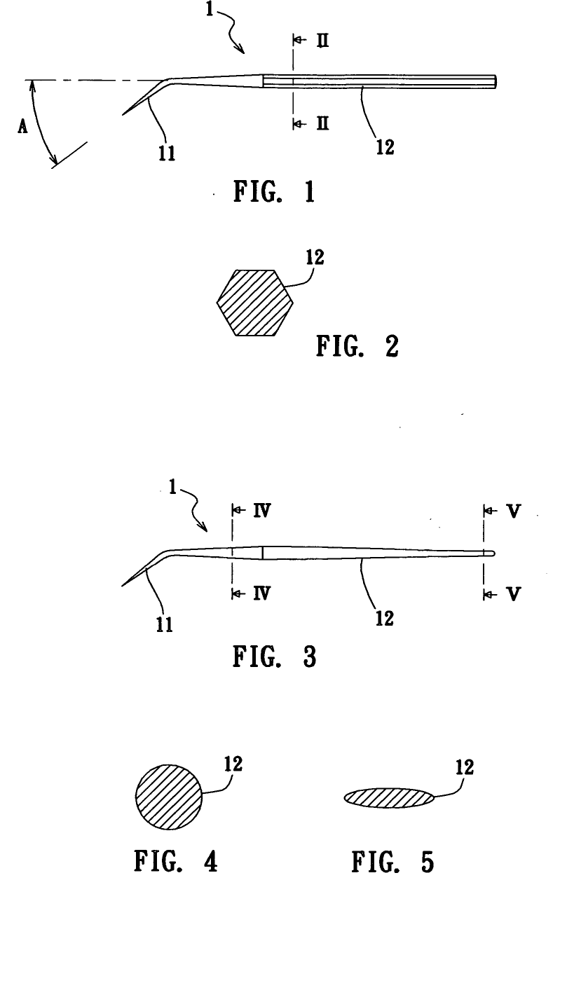

Referring to FIG. 1, a toothpick 1 is shown having a shank 12 and an angular tip 11 at one end of the shank 12. The length of the toothpick 1 is approximately equal to the length of a cigarette. The angular tip 11 is made of metal. The shank 12 can be made of metal, plastics, wood, or any of a variety of suitable materials. The angular tip 11 is fastened to one end of the shank 12 by a plug joint, adhesive, or any of a variety of suitable fastening devices or means. The shank 12 is a straight member. The angular tip 11 is an angular member axially forwardly extended from the shank 12 and then turned in one direction and finally terminating in a point. The angled front part of the angular tip 11 defines with the shank 12 a contained angle A. The contained angle A is designed to be within 10˜60°, preferably within 40˜45°. Therefore, the toothpick 1 can be used as a hand excavator that can be conveniently inserted into the mouth to remove bits of food from the teeth.

For ease of grip by hand, the shank 12 has a polygonal cross section as shown in FIG. 2. Alternatively, the shank 12 can have a circular front end connected to the angular tip 11, a flat rear end away from the angular tip 11, and a sloping peripheral wall sloping from the circular front end to the flat rear end (see FIGS. 3˜5).

The toothpick 1 of the present invention has the following advantages:
1. Ease of use: The angular design of the angular tip 11 allows the toothpick 1 to be used as a dentist's hand excavator that can be conveniently inserted into the mouth to remove bits of food from the teeth.
2. Hygienic design: The toothpick 1 is to be used as one's personal item. The metal angular tip 11 can be sterilized so that the toothpick 1 can be repeatedly used.
3. Environmental protection concept: Because the toothpick 1 is re-usable, it saves consumption of material.

A prototype of toothpick has been constructed with the features of FIGS. 1˜5. The toothpick functions smoothly to provide all of the features discussed earlier.

Although particular embodiments of the invention have been described in detail for purposes of illustration, various modifications and enhancements may be made without departing from the spirit and scope of the invention.

1. A toothpick comprising a shank and a tip at one end of said shank, wherein said tip is an angular member having an angled front part that defines with said shank a contained angle.

2. The toothpick as claimed in claim 1, wherein said contained angle is within 10˜60°.

3. The toothpick as claimed in claim 1, wherein said contained angle is within 40˜45°.

4. The toothpick as claimed in claim 1, wherein said shank has a polygonal cross section.

5. The toothpick as claimed in claim 1, wherein said shank has a circular front end connected to said tip, a flat rear end away from said tip, and a periphery sloping from said circular front end to said flat rear end.
